(19) United States
(12) Patent Application Publication
(10) Pub. No.: US 2018/0315437 A1
(43) Pub. Date: Nov. 1, 2018

(54) Progressive Streaming of Spatial Audio

(71) Applicant: Microsoft Technology Licensing, LLC, Redmond, WA (US)

(72) Inventors: Philip Andrew Edry, Seattle, WA (US); Todd Ryun MANION, Seattle, WA (US); Robert Norman HEITKAMP, Sammamish, WA (US); Steven WILSSENS, Kenmore, WA (US)

(73) Assignee: Microsoft Technology Licensing, LLC, Redmond, WA (US)

(21) Appl. No.: 15/499,989

(22) Filed: Apr. 28, 2017

(51) Int. Cl. G10L 19/24; H04S 7/00; G10L 19/16

(52) U.S. Cl. CPC G10L 19/24; H04S 7/302; H04S 2420/11; H04S 2400/11; H04S 2400/01; G10L 19/167

(57) ABSTRACT

A system for progressively streaming spatial audio is provided. The system includes an engine that adaptively selects encoder(s) to stream spatial audio. Selection can be based upon selection metadata which can be based upon bandwidth, time, computing power, trust, cost, audio endpoint configuration, user criteria and the like. In response to detecting or being informed of a change in selection metadata, the engine can select different encoder(s) based upon the changed selection metadata.

### BACKGROUND

Some traditional software applications are configured to provide a rich surround sound experience. For instance, a video game or a media player can produce a channel-based audio output (e.g., utilizing a Dolby 5.1 surround sound system), a spherical sound representation (e.g., Ambisonics) and/or an object-based audio output. With advancements over the years, some systems can now utilize different technologies involving a growing set of sound objects, higher-resolution spherical sound representation (e.g., higher-order Ambisonics) and/or additional channel(s).

It is with respect to these and other considerations that the disclosure made herein is presented.

### SUMMARY

Described herein is a system for progressively streaming spatial audio comprising a processor and a computer-readable storage medium in communication with the processor, the computer-readable storage medium having computer-executable instructions stored thereupon which, when executed by the processor, cause the processor to select a first encoder for encoding three-dimensional audio data based upon selection metadata, wherein the selection metadata comprises information regarding at least one of a communications channel between the system and one or more endpoint devices, a user associated with the one or more endpoint devices or the one or more endpoint devices; cause the selected first encoder to generate a rendered output signal of the three-dimensional audio data, wherein the rendered output is generated according to an audio spatialization technology; cause a communication of the rendered output signal from the first encoder to one or more endpoint devices for producing an audio output; detect a change in selection metadata; based upon the detected change in selection metadata, select a second encoder for encoding three-dimensional audio data; cause the selected second encoder to generate a rendered output signal of the three-dimensional audio data; and, cause a communication of the rendered output signal from the selected second encoder to the one or more endpoint devices for producing the audio output.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 illustrates an example system for progressively streaming spatial audio.

FIG. 2 illustrates a flow diagram of a routine for progressively streaming spatial audio.

FIG. 3 is a computer architecture diagram illustrating an illustrative computer hardware and software architecture for a computing system capable of implementing aspects of the techniques and technologies presented herein.

### DETAILED DESCRIPTION

The following Detailed Description discloses techniques and technologies pertaining to progressively streaming spatial audio. Aspects of the subject disclosure pertain to the technical problem of adaptively, progressively streaming spatial audio. The technical features associated with addressing this problem involve dynamically selecting an audio spatialization technology and/or associated encoder based upon selection metadata (e.g., bandwidth, temporal, computing power, trust, cost, audio endpoint configuration, user criteria, etc.) The audio spatialization technology and/or associated encoder(s) can be changed, for example, in response to a change in selection metadata. Accordingly, aspects of these technical features exhibit technical effects of more efficiently and effectively streaming spatial audio, for example, reducing computing costs and/or bandwidth consumption.

It should be appreciated that the above-described subject matter may be implemented as a computer-controlled apparatus, a computer process, a computing system, or as an article of manufacture such as a computer-readable storage medium. Among many other benefits, the techniques herein improve efficiencies with respect to a wide range of computing resources. For instance, human interaction with a device may be improved as the use of the techniques disclosed herein enable a user to hear audio generated audio signals as they are intended. In addition, improved human interaction improves other computing resources such as processor and network resources. Other technical effects other than those mentioned herein can also be realized from implementations of the technologies disclosed herein.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

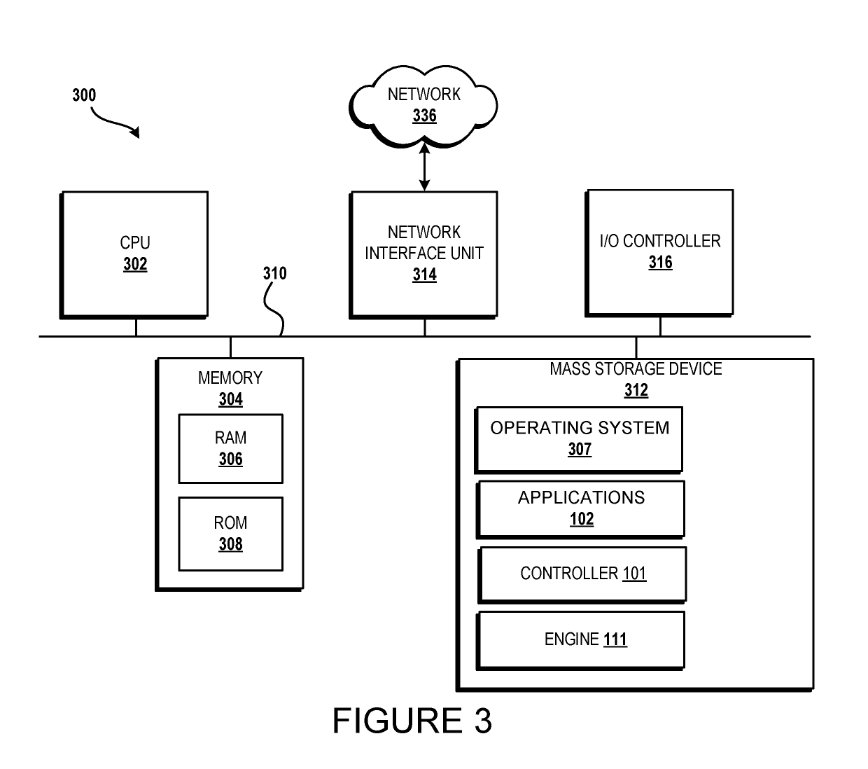

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for enabling a shared three-dimensional audio bed. As will be described in more detail below with respect to FIG. 3, there are a number of applications and modules that can embody the functionality and techniques described herein.

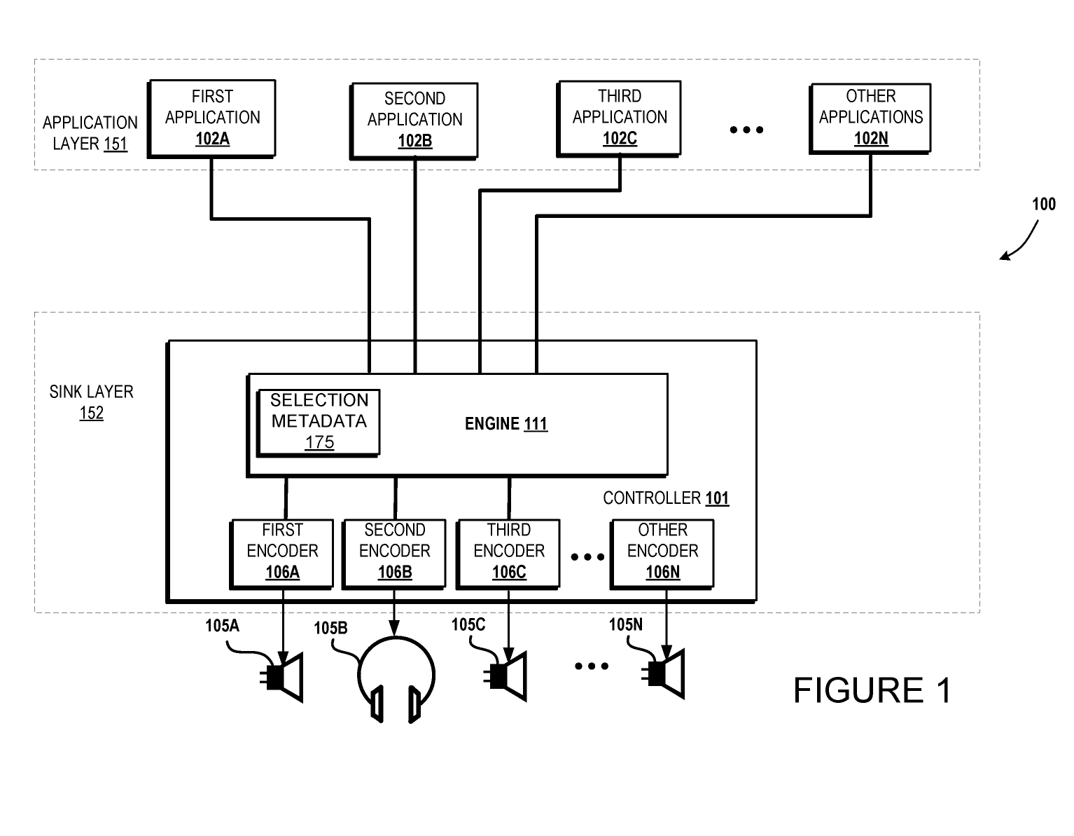

Referring to FIG. 1, a system for progressively streaming spatial audio 100 is illustrated. The system 100 comprises a controller 101 executing at a sink layer 152 for storing, communicating, and processing the audio data described herein. The controller 101 comprises an engine 111 configured to dynamically select one or more encoder(s) 106 to stream spatial audio. Selection can be based, for example, upon selection metadata 175. For example, the selection metadata 175 can include information regarding a communications channel between the system 100 and one or more endpoint devices 105, a user associated with the one or more endpoint devices 105 or the one or more endpoint devices 105.

The controller 101 can comprise a suitable number (N) of encoders 106. For illustrative purposes, some example encoders 106 are individually referred to herein as a first encoder 106A, a second encoder 106B, and a third encoder 106C. The encoders 106 can be associated with a suitable number (N) of output devices 105. For illustrative purposes, some example output devices 105 are individually referred to herein as a first output device 105A, a second output device 105B, a third output device 105C. This example system 100 is provided for illustrative purposes and is not to be construed as limiting. It can be appreciated that the system 100 can include fewer or more components than those shown in FIG. 1.

The encoders 106 are configured to process channel-based audio, spherical audio and/or object-based audio according to one or more selected audio spatialization technologies. A rendered stream generated by an encoder 106 can be communicated to one or more output devices 105. Examples of an output device 105, also referred to herein as an “endpoint device,” include, but are not limited to, speaker systems and headphones. An encoder 106 and/or an output device 105 can be configured to utilize one or more audio spatialization technologies such as Dolby Atmos, HRTF, etc.

The encoders 106 can also implement other functionality, such as one or more echo cancellation technologies. Such technologies are beneficial to select and utilize outside of the application environment, as individual applications do not have any context of other applications, thus can't determine when echo cancelation and other like technologies should be utilized.

In one embodiment, one or more of the encoders 106 can transcode streaming spatial audio based on an audio spatialization technology into different audio spatialization technology. For example, one or more of the encoders 106 can transcode object-based audio received from a particular application 102 into an Ambisonics output (e.g., first-order, higher-order, mixed-order, etc.) which is then provided to output device(s) 105.

The system 100 can progressively stream spatial audio utilizing one or more audio spatialization technology(ies), for example, spherical sound representation such as Ambisonics output (e.g., first-order, higher-order, mixed-order, etc.), object-based audio output, channel-based output and/or any other type of suitable audio output.

Generally described, output data, e.g., an audio output, based on the Ambisonics technology involves a full-sphere surround sound technique. In addition to the horizontal plane, the output data covers sound sources above and below the listener. Thus, in addition to defining a number of other properties for each stream, each stream is associated with a location defined by a three-dimensional coordinate system.

An audio output based on the Ambisonics technology can contain a speaker-independent representation of a sound field called the B-format, which is configured to be decoded by a listener's (spectator or participant) output device. This configuration allows the system 100 to record data in terms of source directions rather than loudspeaker positions, and offers the listener a considerable degree of flexibility as to the layout and number of speakers used for playback. The B-format is a first-order Ambisonics output.

Higher-order Ambisonics refers to a higher resolution audio output in which additional groups of directional components are added to the B-format (e.g., 2^{nd} order, 3^{rd} order . . . N^{th} order). The higher resolution generally consumes greater bandwidth as the additional directional components are added. For example, 2^{nd} order Ambisonics employs eight components, 3^{rd} order Ambisonics employs sixteen components, etc. In order to selectively reduce the additional directional components while maintaining the added benefits of higher-order Ambisonics, mixed-order Ambisonics can selectively remove (e.g., zero-out and/or not transmit, by agreement), directional component(s) of higher-order Ambisonics. For example, directional component(s) having value(s) below a threshold level can be removed to reduce bandwidth consumption.

Object-based audio defines objects that are associated with an audio track. For instance, in a movie, a gunshot can be one object and a person's scream can be another object. Each object can also have an associated position. Metadata of the object-based audio enables applications to specify where each sound object originates and how it should move.

With channel-based output individual channels are associated with objects. For instance, a Dolby 5.1 signal includes multiple channels of audio and each channel can be associated with one or more positions. Metadata can define one or more positions associated with individual channels of a channel-based audio signal.

For illustrative purposes, some example applications 102 are individually referred to herein as a first application 102A, a second application 102B, and a third application 102C. Individual applications 102 can also comprise one or more preprocessors for executing code configured to perform the techniques disclosed herein.

The applications 102 can comprise any executable code configured to process object-based audio (also referred to herein as “3D object audio”), channel-based audio (also referred to herein as “2D bed audio”) and/or spherical sound representation. Examples of the applications 102 can include but, are not limited to, a media player, a web browser, a video game, a virtual reality application, and a communications application. The applications 102 can also include components of an operating system that generate system sounds.

In addition to providing functionality for interacting with a user, the applications 102 can apply one or more operations to object-based audio, including, but not limited to, one or more folding operations and co-location operations, which can involve combining multiple objects into a single object based, for example, upon selection metadata 175 provided by the engine 111. In another example, the applications 102 can utilize one or more culling operations, which can involve the elimination of one or more selected audio objects.

The applications 102 can generate 3D audio data in accordance with the selection metadata 175. In one illustrative example, if the first application 102A is a video game generating raw object-based audio data having 300 audio objects, and the selection metadata 175 specifies an output device 105 having 10 speakers at specific locations of a three-dimensional area, the application 102A can process the 300 audio objects, e.g. fold, co-locate, and/or filter the objects, to appropriately associate individual or combined audio streams of the raw audio data with the 10 speakers and their respective locations. The applications 102 can generate 3D audio data containing the audio data and other definitions associating audio streams with one or more speaker objects.

In some configurations, the system 100 can transition between a first spatialization technology and a second spatialization technology based on one or more actions. For instance, if a user of the system 100 is rendering audio under HRTF, and a user plugs in a Dolby Atmos speaker system or a Dolby Atmos headset, the system can transition from the HRTF spatialization technology to the Dolby Atmos spatialization technology. When the system 100 detects a transition between different spatialization technologies, the system can select encoder(s) 106 that is most appropriate for a selected spatialization technology.

With continued reference to FIG. 1, the engine 111 can utilize selection metadata 175 to select encoder(s) 106 to stream spatial audio to output device(s) 105. The selected encoder(s) 106 can then transmit audio received from application(s) 102 to output device(s) 105.

In one embodiment, the selection metadata 175 identifies a particular spatialization technology (e.g., Ambisonics, object-based audio, channel-based, etc.) and associated audio resolution to be utilized. Based upon the selection metadata 175, the engine 111 can determine particular encoder(s) 106 to transmit the audio.

In one embodiment, the selection metadata 175 specifies particular encoder(s) 106 to be utilized for a particular bandwidth. Based upon information regarding bandwidth available for transmission to a particular output device 105, the engine 111 can determine particular encoder(s) 106 to be utilized. For example, when available bandwidth meets and/or exceeds a threshold specified by the selection metadata 175, the engine 111 utilizes encoder(s) 106 associated with a higher resolution audio (e.g., 7th order Ambisonics and/or full object-based audio data). When available bandwidth does not meet and/or exceed the threshold, the engine 111 utilizes encoder(s) 106 associated with a lower resolution audio (e.g., 1^{st} order Ambisonics and/or decreased number of discretely rendered objects and folded and/or co-located audio objects).

In one embodiment, the selection metadata 175 can specify temporal criteria to be utilized in selecting encoder(s) 106. For example, the selection metadata 175 can specify that for a specified period of time (e.g., two minutes), user(s) are provided a higher resolution audio (e.g., 7^{th} order Ambisonics). Once the specified period of time has expired, the selection metadata 175 can specify that the user(s) are to be provided with a lower resolution audio (e.g., 1^{st} order Ambisonics).

In one embodiment, the selection metadata 175 can specify user criteria to be utilized in selecting encoder(s) 106. For example, the user criteria can include membership in a particular group of users (e.g., paid subscription user, employees of a particular entity, etc.). User(s) meeting the user criteria can be provided with a higher resolution audio (e.g., 7^{th} order Ambisonics) while user(s) not meeting the user criteria can be provided with a lower resolution audio (e.g., 1^{st} order Ambisonics).

In one embodiment, the selection metadata 175 can provide information regarding configuration of a particular output device 105 (e.g., endpoint), for example, that the particular output device 105 is a headphone and/or a particular configuration on a speaker system. Based upon the selection metadata 175, the engine 111 can utilize particular encoder(s) 106 to provide an audio stream to output device(s) 105.

In one embodiment, the selection metadata 175 can provide information regarding computing power associated with a particular output device 105 (e.g., endpoint). For example, the information can indicate that a computing device rendering spatial audio for the particular output device 105 does not have sufficient available computing power to render high resolution spatial audio. Based upon this information, the engine 111 can utilize particular encoder(s) 106 to provide an audio stream to output device(s) 105.

In one embodiment, the selection metadata 175 can provide information regarding a trust level associated with a particular output device 105 and/or a user associated with the particular output device 105. For example, the information can indicate that whether the particular output device 105 and/or the user associated with the particular output device 105 is untrusted or trusted. Based upon an untrusted indication, the engine 111 can utilize particular encoder(s) 106 associated with a lower resolution audio stream to be provided to the particular output device(s) 105. Based upon a trusted indication, the engine 111 can utilize particular encoder(s) 106 associated with a higher resolution audio stream to be provided to the particular output device(s) 105.

Once the system 100 has commenced providing an audio stream via the encoder(s) 106, the system 100 can adaptively change encoder 105 selection and/or setting(s) associated with a selected encoder 105 based, for example, upon change(s) in bandwidth, time, user criteria and/or endpoint configuration as reflected in the selection metadata 175.

In one embodiment, the system 100 can receive updated information regarding bandwidth changes (e.g., reflected in updated selection metadata 175). For example, based upon notification of increased bandwidth availability (e.g., user of mobile device comes into within transmission distance of a Wi-Fi connection), the engine 111 can select encoder(s) 106 associated with a higher resolution audio output (e.g., 7^{th} order Ambisonics, increased number of discretely rendered objects and less folded and/or co-located audio object(s), etc.) in place of a lower resolution audio output (e.g., B-format Ambisonics, decreased number of discretely rendered objects and folded and/or co-located audio object(s), etc.). In one embodiment, in response to a decrease in bandwidth availability, the engine 111 can select encoder(s) 106 associated with a lower resolution audio output in place of a higher resolution audio output.

In one embodiment, based upon determination that a specified period of time has expired (e.g., trial period for higher resolution audio output has expired), the engine 111 can select encoder(s) 106 associated with a lower resolution audio output in place of a higher resolution audio output.

In one embodiment, based upon a determination that user criteria has changed as reflected in the selection metadata 175, the engine 111 can select encoder(s) 106. For example, if the user no longer belongs to a particular group of users (e.g., paid subscription has expired, has left employment of particular entity, etc.), the engine 111 can select encoder(s) 106 associated with a lower resolution audio output in place of encoder(s) 106 associated with a higher resolution audio output. For example, if the user has gained membership to a particular group of users (e.g., paid subscription fee, joined employment of particular entity, etc.), the engine 111 can select encoder(s) 106 associated with a higher resolution audio output in place of a lower resolution audio output.

In one embodiment, based upon a determination that configuration of a particular output device 105 has changed as reflected in the selection metadata 175, the engine 111 can select encoder(s) 106. For example, if the configuration of the particular output device 105 has additional speaker(s) and/or placement of the speaker(s) has been altered in a manner in which higher resolution audio output would be beneficial to the user, the engine 111 can select encoder(s) 106 associated with a higher resolution audio output in place of a lower resolution audio output. If the configuration of the particular output device 105 has less speaker(s) and/or placement of the speaker(s) has been altered in a manner in which higher resolution audio output would not be beneficial to the user, the engine 111 can select encoder(s) 106 associated with a lower resolution audio output in place of a higher solution audio output.

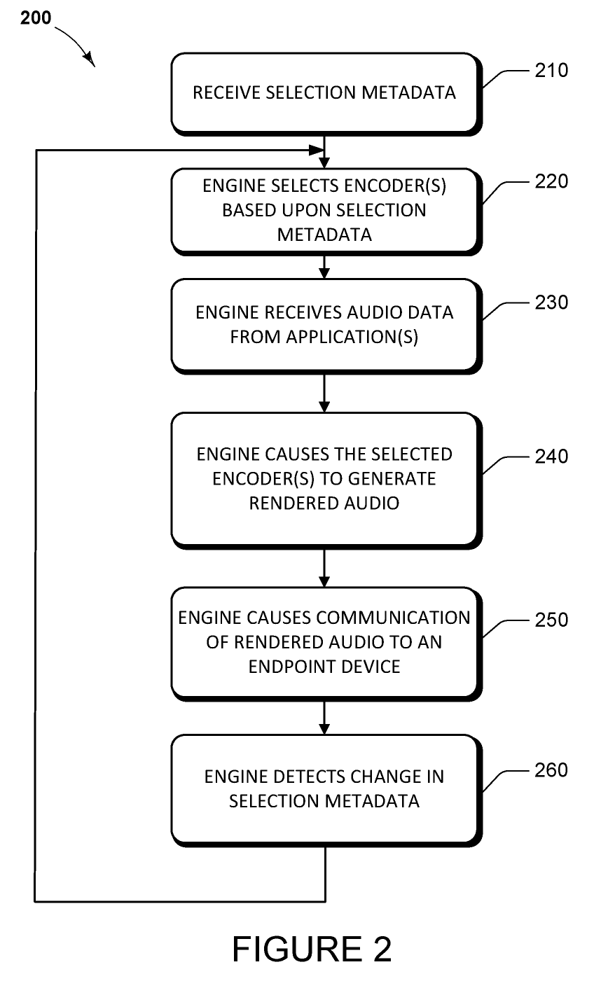

Turning now to FIG. 2, aspects of a method 200 (e.g., routine) for progressively streaming spatial audio is shown and described. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the method 200 are described herein as being implemented, at least in part, by an application, component and/or circuit, such as the controller 101. In some configurations, the controller 101 can be a dynamically linked library (DLL), a statically linked library, functionality produced by an application programming interface (API), a compiled program, an interpreted program, a script or any other executable set of instructions. Data and/or modules, engine 111, can be stored in a data structure in one or more memory components. Data can be retrieved from the data structure by addressing links or references to the data structure.

Although the following illustration refers to the components of FIG. 1 and FIG. 3, it can be appreciated that the operations of the method 200 may be also implemented in many other ways. For example, the method 200 may be implemented, at least in part, by a processor of another remote computer or a local circuit. In addition, one or more of the operations of the routine 200 may alternatively or additionally be implemented, at least in part, by a chipset working alone or in conjunction with other software modules. Any service, circuit or application suitable for providing the techniques disclosed herein can be used in operations described herein.

With reference to FIG. 2, at operation 210, selection metadata is retrieved. For example, the engine 111 can receive selection metadata 175. At 220, an engine selects encoder(s) based upon the selection metadata. At 230, the engine receives audio data from application(s).

At 240, the engine causes the selected encoder(s) to generate rendered audio. At 250, the engine causes communication of the rendered audio to an endpoint device. At 260, the engine detects a change in selection metadata and processing continues at 220.

Described herein is a system for progressively streaming spatial audio, comprising: a processor and a computer-readable storage medium in communication with the processor, the computer-readable storage medium having computer-executable instructions stored thereupon which, when executed by the processor, cause the processor to select a first encoder for encoding three-dimensional audio data based upon selection metadata, wherein the selection metadata comprises information regarding at least one of a communications channel between the system and one or more endpoint devices, a user associated with the one or more endpoint devices or the one or more endpoint devices; cause the selected first encoder to generate a rendered output signal of the three-dimensional audio data, wherein the rendered output is generated according to an audio spatialization technology; cause a communication of the rendered output signal from the first encoder to the one or more endpoint devices for producing an audio output; detect a change in the selection metadata; based upon the detected change in the selection metadata, select a second encoder for encoding three-dimensional audio data; cause the selected second encoder to generate a rendered output signal of the three-dimensional audio data; and cause a communication of the rendered output signal from the selected second encoder to the one or more endpoint devices for producing the audio output.

The system can include wherein at least one of the first encoder or the second encoder generates the rendered output signal of the three-dimensional audio data using a first-order spherical sound representation. The system can further include wherein at least one of the first encoder or the second encoder generates the rendered output signal of the three-dimensional audio data using a higher-order spherical sound representation.

The system can include wherein at least one of the first encoder or the second encoder generates the rendered output signal of the three-dimensional audio data using a mixed-order spherical sound representation. The system can further include wherein at least one of the first encoder or the second encoder generates the rendered output signal of the three-dimensional audio data using an object-based audio output.

The system can include wherein at least one of the first encoder or the second encoder generates the rendered output signal of the three-dimensional audio data using an object-based audio output utilizing at least one of a folded or a co-located audio object. The system can further include wherein the selection metadata comprises at least one of an available bandwidth, a bandwidth threshold for higher resolution audio or a bandwidth threshold for lower resolution audio.

The system can include wherein the selection metadata comprises user criteria and wherein a user meeting the user criteria is provided higher resolution audio than a user not meeting the user criteria. The system can further include wherein the selection metadata comprises information regarding configuration of the one or more endpoint devices for producing the audio output.

Described herein is a system for progressively streaming spatial audio, comprising: a plurality of encoders, each encoder configured to generate a rendered output signal of three-dimensional audio data according to a particular spatialization technology; and an engine configured to select a first encoder of the one or more of the plurality of encoders based upon selection metadata, the engine further configured to cause the selected first encoder to communicate a rendered output signal to one or more endpoint devices for producing an audio output, the engine further configured to dynamically select a second one or more of the plurality of encoders based upon a change in the selection metadata.

The system can include wherein at least one of the first encoder or the second encoder generates the rendered output signal of the three-dimensional audio data using a first-order spherical sound representation. The system can further include wherein at least one of the first encoder or the second encoder generates the rendered output signal of the three-dimensional audio data using a higher-order spherical sound representation.

The system can include wherein at least one of the first encoder or the second encoder generates the rendered output signal of the three-dimensional audio data using an object-based audio output. The system can further include wherein the selection metadata comprises at least one of an available bandwidth, a bandwidth threshold for higher resolution audio or a bandwidth threshold for lower resolution audio.

Described herein is a method comprising selecting a first encoder for encoding three-dimensional audio data based upon selection metadata; causing the selected first encoder to generate a rendered output signal of the three-dimensional audio data, wherein the rendered output is generated according to an audio spatialization technology; causing a communication of the rendered output signal from the first encoder to one or more endpoint devices for producing an audio output; detecting a change in the selection metadata; based upon the detected change in the selection metadata, selecting a second encoder for encoding three-dimensional audio data; causing the selected second encoder to generate a rendered output signal of the three-dimensional audio data; and causing a communication of the rendered output signal from the selected second encoder to the one or more endpoint devices for producing the audio output.

The method can include wherein the selection metadata comprises at least one of an available bandwidth, a bandwidth threshold for higher resolution audio or a bandwidth threshold for lower resolution audio. The method can further include wherein the selection metadata comprises user criteria and wherein a user meeting the user criteria is provided higher resolution audio than a user not meeting the user criteria.

The method can include wherein the selection metadata comprises information regarding configuration of the one or more endpoint devices for producing the audio output. The method can further include wherein at least one of the first encoder or the second encoder generates the rendered output signal of the three-dimensional audio data using an object-based audio output utilizing at least one of a folded or a co-located audio object. The method can include wherein at least one of the first encoder or the second encoder generates the rendered output signal of the three-dimensional audio data using a mixed-order spherical sound representation.

FIG. 3 shows additional details of an example computer architecture 300 for a computer, such as the controller 101 (FIG. 1), capable of executing the program components described herein. Thus, the computer architecture 300 illustrated in FIG. 3 illustrates an architecture for a server computer, mobile phone, a PDA, a smart phone, a desktop computer, a netbook computer, a tablet computer, and/or a laptop computer. The computer architecture 300 may be utilized to execute any aspects of the software components presented herein.

The computer architecture 300 illustrated in FIG. 3 includes a central processing unit 302 (“CPU”), a system memory 304, including a random access memory 306 (“RAM”) and a read-only memory (“ROM”) 308, and a system bus 310 that couples the memory 304 to the CPU 302. A basic input/output system containing the basic routines that help to transfer information between elements within the computer architecture 300, such as during startup, is stored in the ROM 308. The computer architecture 300 further includes a mass storage device 312 for storing an operating system 307, one or more applications 102, the controller 101, the engine 111, and other data and/or modules.

The mass storage device 312 is connected to the CPU 302 through a mass storage controller (not shown) connected to the bus 310. The mass storage device 312 and its associated computer-readable media provide non-volatile storage for the computer architecture 300. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 300.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 300. For purposes the claims, the phrase “computer storage medium,” “computer-readable storage medium” and variations thereof, does not include waves, signals, and/or other transitory and/or intangible communication media, per se.

According to various configurations, the computer architecture 300 may operate in a networked environment using logical connections to remote computers through the network 356 and/or another network (not shown). The computer architecture 300 may connect to the network 356 through a network interface unit 314 connected to the bus 310. It should be appreciated that the network interface unit 314 also may be utilized to connect to other types of networks and remote computer systems. The computer architecture 300 also may include an input/output controller 316 for receiving and processing input from a number of other devices, including a keyboard, mouse, or electronic stylus (not shown in FIG. 3). Similarly, the input/output controller 316 may provide output to a display screen, a printer, or other type of output device (also not shown in FIG. 3).

It should be appreciated that the software components described herein may, when loaded into the CPU 302 and executed, transform the CPU 302 and the overall computer architecture 300 from a general-purpose computing system into a special-purpose computing system customized to facilitate the functionality presented herein. The CPU 302 may be constructed from any number of transistors or other discrete circuit elements, which may individually or collectively assume any number of states. More specifically, the CPU 302 may operate as a finite-state machine, in response to executable instructions contained within the software modules disclosed herein. These computer-executable instructions may transform the CPU 302 by specifying how the CPU 302 transitions between states, thereby transforming the transistors or other discrete hardware elements constituting the CPU 302.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 300 in order to store and execute the software components presented herein. It also should be appreciated that the computer architecture 300 may include other types of computing devices, including hand-held computers, embedded computer systems, personal digital assistants, and other types of computing devices known to those skilled in the art. It is also contemplated that the computer architecture 300 may not include all of the components shown in FIG. 3, may include other components that are not explicitly shown in FIG. 3, or may utilize an architecture completely different than that shown in FIG. 3.

### CONCLUSION

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A system for progressively streaming spatial audio, comprising:
a processor;
a computer-readable storage medium in communication with the processor, the computer-readable storage medium having computer-executable instructions stored thereupon which, when executed by the processor, cause the processor to:
select a first encoder for encoding three-dimensional audio data based upon selection metadata, the first encoder utilizing a first-order spherical sound representation, a higher-order spherical sound representation, a mixed-order spherical sound representation, or an object-based audio output utilizing at least one of a folded or a co-located audio object, wherein the selection metadata comprises information regarding at least one of a communications channel between the system and one or more endpoint devices, a user associated with the one or more endpoint devices or the one or more endpoint devices;
cause the selected first encoder to generate a rendered output signal of the three-dimensional audio data, wherein the rendered output is generated according to an audio spatialization technology;
cause a communication of the rendered output signal from the first encoder to the one or more endpoint devices for producing an audio output;
detect a change in the selection metadata;
based upon the detected change in the selection metadata, dynamically select a second encoder for encoding three-dimensional audio data, the second encoder utilizing a first-order spherical sound representation, a higher-order spherical sound representation, a mixed-order spherical sound representation, or an object-based audio output utilizing at least one of a folded or a co-located audio object, wherein the second encoder is different than the first encoder;
cause the selected second encoder to generate a rendered output signal of the three-dimensional audio data; and
cause a communication of the rendered output signal from the selected second encoder to the one or more endpoint devices for producing the audio output.

2-6. (canceled)

7. The system of claim 1, wherein the selection metadata comprises at least one of an available bandwidth, a bandwidth threshold for higher resolution audio or a bandwidth threshold for lower resolution audio.

8. The system of claim 1, wherein the selection metadata comprises user criteria and wherein a user meeting the user criteria is provided higher resolution audio than a user not meeting the user criteria.

9. The system of claim 1, wherein the selection metadata comprises information regarding configuration of the one or more endpoint devices for producing the audio output.

10. A system for progressively streaming spatial audio, comprising:
a plurality of encoders, each encoder configured to generate a rendered output signal of three-dimensional audio data according to a particular spatialization technology; and
an engine configured to select a first encoder of the one or more of the plurality of encoders based upon selection metadata, the first encoder utilizing a first-order spherical sound representation, a higher-order spherical sound representation, a mixed-order spherical sound representation, or an object-based audio output utilizing at least one of a folded or a co-located audio object, the engine further configured to cause the selected first encoder to communicate a rendered output signal to one or more endpoint devices for producing an audio output, the engine further configured to dynamically select a second one or more of the plurality of encoders based upon a change in the selection metadata, the second encoder utilizing a first-order spherical sound representation, a higher-order spherical sound representation, a mixed-order spherical sound representation, or an object-based audio output utilizing at least one of a folded or a co-located audio object, wherein the second encoder is different than the first encoder.

11-13. (canceled)

14. The system of claim 10, wherein the selection metadata comprises at least one of an available bandwidth, a bandwidth threshold for higher resolution audio or a bandwidth threshold for lower resolution audio.

15. A method, comprising:
selecting a first encoder for encoding three-dimensional audio data based upon selection metadata, the first encoder utilizing a first-order spherical sound representation, a higher-order spherical sound representation, a mixed-order spherical sound representation, or an object-based audio output utilizing at least one of a folded or a co-located audio object;
causing the selected first encoder to generate a rendered output signal of the three-dimensional audio data, wherein the rendered output is generated according to an audio spatialization technology;
causing a communication of the rendered output signal from the first encoder to one or more endpoint devices for producing an audio output;
detecting a change in the selection metadata;
based upon the detected change in the selection metadata, dynamically selecting a second encoder for encoding three-dimensional audio data, the second encoder utilizing a first-order spherical sound representation, a higher-order spherical sound representation, a mixed-order spherical sound representation, or an object-based audio output utilizing at least one of a folded or a co-located audio object, wherein the second encoder is different than the first encoder;
causing the selected second encoder to generate a rendered output signal of the three-dimensional audio data; and
causing a communication of the rendered output signal from the selected second encoder to the one or more endpoint devices for producing the audio output.

16. The method of claim 15, wherein the selection metadata comprises at least one of an available bandwidth, a bandwidth threshold for higher resolution audio or a bandwidth threshold for lower resolution audio.

17. The method of claim 15, wherein the selection metadata comprises user criteria and wherein a user meeting the user criteria is provided higher resolution audio than a user not meeting the user criteria.

18. The method of claim 15, wherein the selection metadata comprises information regarding configuration of the one or more endpoint devices for producing the audio output.

19-20. (canceled)
